(19) United States
(12) Patent Application Publication
(10) Pub. No.: US 2026/0031859 A1
(43) Pub. Date: Jan. 29, 2026

(54) DEVICES AND METHODS FOR COORDINATED TRANSMISSION IN A WIRELESS NETWORK

(71) Applicant: HUAWEI TECHNOLOGIES CO., LTD., Shenzhen (CN)

(72) Inventors: Genadiy TSODIK, Hod Hasharon (IL); Arik KLEIN, Hod Hasharon (IL); Shimon SHILO, Hod Hasharon (IL); Oded REDLICH, Hod Hasharon (IL)

(21) Appl. No.: 19/348,120

(22) Filed: Oct. 2, 2025

Related U.S. Application Data
(63) Continuation of application No. PCT/EP2023/058911, filed on Apr. 5, 2023.

(51) Int. Cl. H04B 7/024; H04W 74/0808; H04W 84/12

(52) U.S. Cl. CPC H04B 7/024; H04W 74/0808; H04W 84/12

(57) ABSTRACT

This disclosure relates to a shared access point, AP, (120) configured to participate in a coordinated transmission making use of at least a portion of at least one transmission opportunity, TXOP, obtained and shared by a sharing AP (110) operating under a coordination agreement within a Multi-AP, M-AP, set. The shared AP (120) comprises a processing circuitry (121) configured to modify at least one parameter of a plurality of coordination operation related parameters. Moreover, the shared AP (120) comprises a communication interface (123) configured to transmit a frame to the sharing AP (110). The frame comprises a coordination status field comprising information indicative of the at least one modified parameter of the plurality of coordination operation related parameters.

### CROSS-REFERENCE TO RELATED APPLICATIONS

This application is a continuation of International Application No. PCT/EP2023/058911, filed on Apr. 5, 2023, the disclosure of which is hereby incorporated by reference in its entirety.

### TECHNICAL FIELD

The present disclosure relates to wireless communications. More specifically, the present disclosure relates to devices and methods for coordinated transmission in a wireless communication network, in particular an IEEE 802.11-based WLAN.

### BACKGROUND

IEEE 802.11-based WLANs (also referred to as Wi-Fi networks) have become popular at an unprecedented rate. 802.11be introduces a Multi AP (M-AP) coordinated transmission, for instance, a coordinated beamforming transmission, where a group of access points (APs) may initiate concurrent frame exchange within a limited time period and one AP of the group of APs shares one or more obtained transmission opportunities (TXOPs). The group of APs that have decided to cooperate and perform coordinated transmissions is called a M-AP set.

### SUMMARY

It is an objective to provide improved devices and methods for AP coordinated transmission in a wireless communication network, in particular an IEEE 802.11 based WLAN.

The foregoing and other objectives are achieved by the subject matter of the independent claims. Further implementation forms are apparent from the dependent claims, the description and the figures.

According to a first aspect, a shared access point, AP, is provided. The shared AP is configured to participate in a coordinated transmission to one or more non-AP stations associated with the shared AP and one or more further non-AP stations associated with a sharing AP making use of at least a portion of at least one transmission opportunity, TXOP, obtained and shared by the sharing AP operating under a coordination agreement within a Multi-AP, M-AP, set. The shared AP comprises a processing circuitry configured to modify at least one parameter of a plurality of coordination operation related parameters used by the shared AP for the coordinated transmission. The shared AP further comprises a communication interface configured to include a coordination status field within a frame transmitted to the sharing AP. The coordination status field comprises information indicative of the at least one modified parameter of the plurality of coordination operation related parameters. Thus, a coordination status update can be indicated in an efficient and flexible way and a plurality of changes can be indicated with the same indication.

In a further possible implementation form of the first aspect, the frame further comprises an indication, in particular a flag bit, indicating the presence of the coordination status field in the frame.

In a further possible implementation form of the first aspect, the coordination status field comprises a bitmap, wherein each bit of the bitmap corresponds to one parameter of the plurality of coordination operation related parameters and wherein a value of each bit is indicative of whether the corresponding parameter has been modified.

In a further possible implementation form of the first aspect, the bitmap comprises a plurality of bits.

In a further possible implementation form of the first aspect, the coordination status field comprises an encoded value of a set of encoded values, wherein each encoded value corresponds to one parameter of the plurality of coordination operation related parameters and is indicative of whether the corresponding parameter has been modified.

In a further possible implementation form of the first aspect, the set of encoded values comprises a plurality of sequences of 3-bit values.

In a further possible implementation form of the first aspect, the set of encoded values comprises a value indicating no change of the at least one parameter of the plurality of coordination operation related parameters.

In a further possible implementation form of the first aspect, the frame further comprises a coordination status parameter field comprising information indicative of a value of the at least one modified parameter indicated in the coordination status field of the plurality of coordination operation related parameters.

In a further possible implementation form of the first aspect, the coordination status field comprises a set of subfields where each subfield comprises a value of one of the coordination operation related parameters of the set of values corresponding to that parameter.

In a further possible implementation form of the first aspect, the set of values of each of coordination operation related parameters includes a value indicating no change of the corresponding parameter.

In a further possible implementation form of the first aspect, the plurality of coordination operation related parameters comprises a parameter indicative of a change in the coordinated transmission bandwidth, a parameter indicative of a change in the number of transmission spatial streams for the coordinated transmission, a parameter indicative of a change in the number of reception spatial streams for the coordinated transmission, a parameter indicative of a pause of the shared AP participating in the current coordinated transmission taking place in any time portion till the end of the coordination agreement and/or a parameter indicative of the shared AP no longer being a member of the coordination agreement within the M-AP set.

In a further possible implementation form of the first aspect, the communication interface is configured to transmit the frame to the sharing AP, after receiving a trigger frame from the sharing AP.

In a further possible implementation form of the first aspect, the communication interface is configured to receive a coordination status poll frame from the sharing AP and to transmit the frame to the sharing AP.

In a further possible implementation form of the first aspect, the communication interface is configured to receive a M-AP status update frame from the sharing AP, wherein the M-AP status update frame comprises a coordination status field comprising information indicative of at least one parameter of a plurality of coordination operation related parameters, wherein the at least one parameter has been modified by the sharing AP or a further shared AP of the current coordination agreement.

In a further possible implementation form of the first aspect, in response to receiving the M-AP status update frame from the sharing AP, the communication interface is configured to transmit an acknowledgment frame to the sharing AP.

In a further possible implementation form of the first aspect, the M-AP status update frame comprises a M-AP set identifier indicative of the M-AP set.

In a further possible implementation form of the first aspect, the M-AP status update frame further comprises a coordination agreement identifier within the M-AP set. The coordination agreement identifier may identify one coordination agreement of a plurality of coordination agreements within the M-AP set and the sharing AP and the shared AP may operate under the coordination agreement identified by the coordination agreement identifier within the M-AP set.

According to a second aspect, a method is provided of operating a shared access point, AP, configured to participate in a coordinated transmission to one or more non-AP stations associated with the shared AP and one or more further non-AP stations associated with a sharing AP making use of at least a portion of at least one transmission opportunity, TXOP, obtained and shared by a sharing AP operating under a coordination agreement within a Multi-AP, M-AP, set. The method comprises the following steps:
modifying at least one parameter of a plurality of coordination operation related parameters used by the shared AP for the coordinated transmission; and
Including a coordination status field within a frame transmitted to the sharing AP, wherein the coordination status field comprises information indicative of the at least one modified parameter of the plurality of coordination operation related parameters.

The method according to the second aspect of the present disclosure can be performed by the shared AP according to the first aspect of the present disclosure. Thus, further features of the method according to the second aspect of the present disclosure result directly from the functionality of the shared AP according to the first aspect of the present disclosure as well as its different implementation forms described above and below.

According to a third aspect, a sharing access point, AP, is provided. The sharing AP is configured to share at least a portion of a transmission opportunity, TXOP, with a plurality of shared APs operating under a coordination agreement within a Multi-AP, M-AP, set for participating in a coordinated transmission to one or more non-AP stations associated with the sharing AP and a plurality of further non-AP stations associated with the plurality of shared APs. The sharing AP comprises a communication interface configured to receive a frame from one of the plurality of shared APs, wherein the frame comprises a coordination status field comprising information indicative of at least one modified parameter of a plurality of coordination operation related parameters used by the shared AP for the coordinated transmission. Thus, a coordination status update can be indicated in an efficient and flexible way and a plurality of changes can be indicated with the same frame.

In a further possible implementation form of the third aspect, the frame further comprises an indication, in particular a flag bit, indicating the presence of the coordination status field.

In a further possible implementation form of the third aspect, the coordination status field comprises a bitmap, wherein each bit of the bitmap corresponds to one parameter of the plurality of coordination operation related parameters and wherein a value of each bit is indicative of whether the corresponding parameter has been modified.

In a further possible implementation form of the third aspect, the bitmap comprises a plurality of bits.

In a further possible implementation form of the third aspect, the coordination status field comprises an encoded value of a set of encoded values, wherein each encoded value corresponds to one parameter of the plurality of coordination operation related parameters and is indicative of whether the corresponding parameter has been modified.

In a further possible implementation form of the third aspect, the set of encoded values comprises a plurality of sequences of 3-bit values.

In a further possible implementation form of the third aspect, the set of encoded values comprises a value indicating no change of the at least one parameter of the plurality of coordination operation related parameters.

In a further possible implementation form of the third aspect, the frame further comprises a coordination status parameter field comprising information indicative of a value of the at least one modified parameter indicated in the coordination status field of the plurality of coordination operation related parameters.

In a further possible implementation form of the third aspect, the coordination status field comprises a set of subfields where each subfield comprises a value of one of the coordination operation related parameters of the set of values corresponding to that parameter.

In a further possible implementation form of the third aspect, the set of values of each of coordination operation related parameters includes a value indicating no change of the corresponding parameter.

In a further possible implementation form of the third aspect, the plurality of coordination operation related parameters comprises a parameter indicative of a change in the coordinated transmission bandwidth, a parameter indicative of a change in the number of transmission spatial streams for the coordinated transmission, a parameter indicative of a change in the number of reception spatial streams for the coordinated transmission, a parameter indicative of a pause of the shared AP participating in the current coordinated transmission taking place in any time portion till the end of the coordination agreement and/or a parameter indicative of the shared AP no longer being a member of the coordination agreement within the M-AP set.

In a further possible implementation form of the third aspect, the frame further comprises a coordination status parameter field comprising information indicative of a value of the at least one modified parameter of the plurality of coordination operation related parameters.

In a further possible implementation form of the third aspect, the coordination status field comprises a bitmap. Each bit of the bitmap may correspond to one parameter of the plurality of coordination operation related parameters and a value of each bit may be indicative of whether the corresponding parameter has been modified or not.

In a further possible implementation form of the third aspect, each bitmap comprises a plurality of bits.

In a further possible implementation form of the third aspect, the coordination status field comprises a bit sequence codeword of a set of codewords. Each codeword of the set of codewords may correspond to one parameter of the plurality of coordination operation related parameters and is indicative of whether the corresponding parameter has been modified or not.

In a further possible implementation form of the third aspect, the set of codewords comprises a plurality of sequences of 3 bits.

In a further possible implementation form of the third aspect, the set of codewords comprises a codeword indicating no change of the at least one parameter of the plurality of coordination operation related parameters.

In a further possible implementation form of the third aspect, the plurality of coordination operation related parameters used by the shared AP for the coordinated transmission comprises a parameter indicative of a coordinated transmission bandwidth, a parameter indicative of a number of transmission spatial streams for the coordinated transmission, a parameter indicative of a number of reception spatial streams for the coordinated transmission, a parameter indicative of a pause of the shared AP participating in the coordinated transmission and/or a parameter indicative of the shared AP no longer being a member of the coordination agreement within the M-AP set.

In a further possible implementation form of the third aspect, the communication interface is configured to send a trigger frame to the shared AP for informing the shared AP to transmit the frame to the sharing AP.

In a further possible implementation form of the third aspect, the communication interface is configured to send a coordination status poll frame to the shared AP.

In a further possible implementation form of the third aspect, the communication interface is configured to transmit a M-AP status update frame to at least one further shared AP of the plurality of shared APs, wherein the M-AP status update frame comprises a coordination status field comprising the information indicative of the at least one modified parameter of the plurality of coordination operation related parameters.

In a further possible implementation form of the third aspect, the M-AP status update frame comprises a M-AP set identifier indicative of the M-AP set.

In a further possible implementation form of the third aspect, the M-AP status update frame further comprises a coordination agreement identifier within the M-AP set, wherein the coordination agreement identifier identifies one coordination agreement of a plurality of coordination agreements within the M-AP set and wherein the sharing AP and the plurality of shared APs operate under the coordination agreement identified by the coordination agreement identifier within the M-AP set.

According to a fourth aspect, a method is provided of operating a sharing access point, AP, configured to share at least a portion of a transmission opportunity, TXOP, with a plurality of shared APs operating under a coordination agreement within a Multi-AP, M-AP, set for participating in a coordinated transmission to one or more non-AP stations associated with the sharing AP and a plurality of further non-AP stations associated with the plurality of shared APs. The method comprises the following step: receiving a frame from one of the plurality of shared APs, wherein the frame comprises a coordination status field comprising information indicative of an identity of at least one modified parameter of a plurality of coordination operation related parameters used by the shared AP for the coordinated transmission.

In a further possible implementation form of the fourth aspect, the method further comprises a step of transmitting a M-AP status update frame to at least one further shared AP of the plurality of shared APs, wherein the M-AP status update frame comprises a coordination status field comprising the information indicative of an identity of the at least one modified parameter of the plurality of coordination operation related parameters.

The method according to the fourth aspect of the present disclosure can be performed by the sharing AP according to the third aspect of the present disclosure. Thus, further features of the method according to the fourth aspect of the present disclosure result directly from the functionality of the sharing AP according to the third aspect of the present disclosure as well as its different implementation forms described above and below.

According to a fifth aspect, a computer program product, comprising a computer-readable storage medium for storing program code which causes a computer or a processor to perform the method of the second aspect or the method of the fourth aspect when the program code is executed by the computer or the processor, is provided.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows an exemplary wireless communication network including a sharing AP and a shared AP for coordinated transmission according to an embodiment;

FIG. 2a illustrates a conventional M-AP coordinated transmission flow scheme;

FIG. 2b illustrates using a Status Update poll trigger frame to receive a status update report for any change in coordination parameters;

FIG. 3 shows the inclusion of a coordination status field within a frame transmitted by a shared AP to a sharing AP according to an embodiment during a general sequential procedure;

FIG. 3a shows the inclusion of a coordination status field within a complete indication frame transmitted by a shared AP to a sharing AP according to an embodiment during a sequential procedure in the form of a Coordinated Beamforming (CoBF) sounding procedure;

FIG. 4a shows a schematic diagram illustrating a bit map data structure of a coordination status field of a frame transmitted by a shared AP according to an embodiment;

FIG. 4b shows a schematic diagram illustrating an encoding bit sequence data structure of a coordination status field of a frame transmitted by a shared AP according to an embodiment;

FIG. 4c shows a schematic diagram illustrating a data structure of a coordination status parameter field of a frame transmitted by a shared AP according to an embodiment;

FIG. 4d shows a schematic diagram illustrating a data structure of a coordination status field of a frame transmitted by a shared AP according to an embodiment;

FIG. 5 shows a schematic diagram illustrating a coordination status field presence indication in a frame send by a shared AP according to an embodiment;

FIG. 6 shows a schematic diagram illustrating a transmission of a M-AP status update frame by a sharing AP according to an embodiment;

FIG. 7 is a flow diagram illustrating a method of operating a shared AP according to an embodiment; and

FIG. 8 is a flow diagram illustrating a method of operating a sharing AP according to an embodiment.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

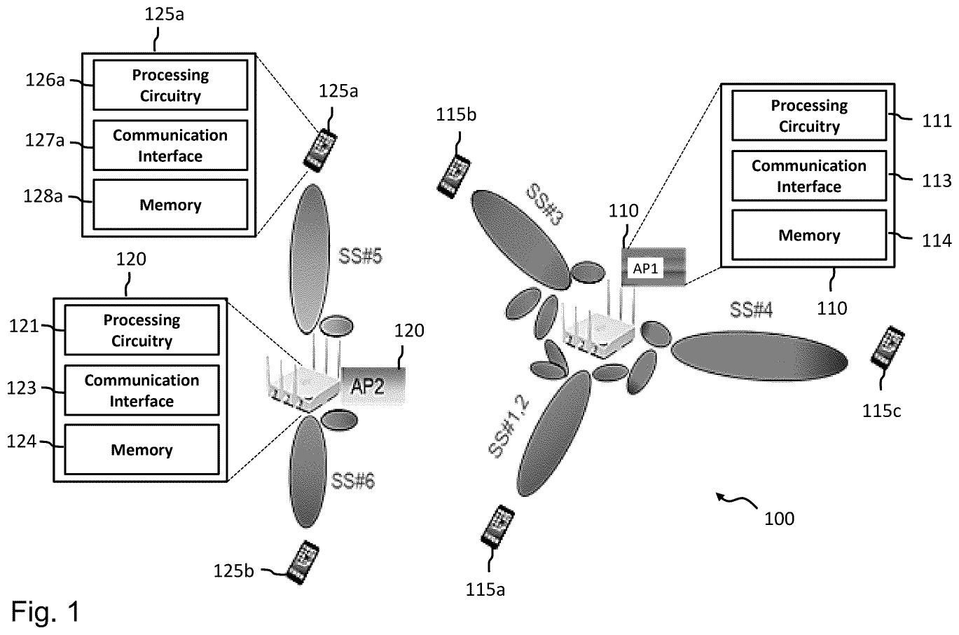

FIG. 1 shows an exemplary wireless communication network 100 including a sharing AP 110 with a plurality of associated non-AP stations 115a-c and a shared AP 120 with a plurality of associated non-AP stations 125a,b (also referred to as STAs 125a,b) for coordinated transmission according to an embodiment. As will be appreciated and will be described in more detail below, being the sharing AP and the shared AP can be considered roles or functions that in the exemplary scenario shown in FIG. 1 are provided by the sharing AP 110 and the shared AP 120, but may be reversed for a further coordinated transmission. In other words, in a further coordinated transmission the AP 120 may act as the sharing AP, while the AP 110 is the shared AP.

The wireless communication network 100 may be a WLAN in accordance with the IEEE 802.11 framework of standards (also referred to as a Wi-Fi network 100). Although for the sake of clarity only a single shared AP 120 is shown in FIG. 1 with its associated non-AP stations 125a,b, embodiments disclosed herein may be implemented may be implemented with a plurality of shared APs 120 like the exemplary shared AP 120 shown in FIG. 1.

By way of example, FIG. 1 illustrates the scenario of a coordinated beamforming transmission (also referred to as CoBF transmission). As will be appreciated, however, embodiments disclosed herein may be implemented with other types of coordinated transmission schemes as well. CoBF transmission is a coordination scheme proposed for next generation Wi-Fi for simultaneous data transmission by several APs. This coordination scheme assumes that each participating AP has the capability to precode its transmitted signal such that mutual interference between this AP and the non-AP stations, i.e. STAs of the OBSS (Overlapping BSS) during coordinated transmission is minimized (also referred to as nulling). Similarly to all other coordination schemes, CoBF is initialized by a sharing AP that proposes other APs (referred to as shared APs) to transmit simultaneously. The proposed resources in this case are spatial streams, where the sharing AP assigns a specific respective number of spatial streams to each shared AP. CoBF may make use of an additional sounding procedure for estimating the channels between the APs and the non-AP stations. Based on the estimated channels the APs may construct precoder matrices for generating beams and nulls toward the non-AP stations that participate in the current CoBF transmissions.

The sharing AP 110 shown in FIG. 1 is configured to share at least a portion of a transmission opportunity, TXOP, with the shared AP 120 under the same coordination agreement within a Multi-AP set (also referred to as M-AP set) for participating in a coordinated transmission, for instance a coordinated beamforming transmission. As illustrated in FIG. 1, the sharing AP 110 comprises a processing circuitry 111 and a communication interface 113, in particular a wireless communication interface 113 in accordance with the IEEE 802.11 framework of standards. The processing circuitry 111 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The sharing AP 110 may further comprise a memory 114 configured to store executable program code which, when executed by the processing circuitry 111, causes the sharing AP 110 to perform the functions and methods described herein.

Likewise, the exemplary shared AP 120 illustrated in FIG. 1 comprises a processing circuitry 121 and a communication interface 123, in particular a wireless communication interface 123 in accordance with the IEEE 802.11 framework of standards. The processing circuitry 121 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The shared AP 120 may further comprise a memory 124 configured to store executable program code which, when executed by the processing circuitry 121, causes the exemplary shared AP 120 to perform the functions and methods described herein.

Likewise, the exemplary non-AP station 125a associated with the exemplary shared AP 120 illustrated in FIG. 1 comprises a processing circuitry 126a and a communication interface 127a, in particular a wireless communication interface 127a in accordance with the IEEE 802.11 framework of standards. The processing circuitry 126a may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. The exemplary non-AP station 125a may further comprise a memory 128a configured to store executable program code which, when executed by the processing circuitry 126a, causes the exemplary non-AP station 125a to perform the functions and methods described herein.

Several coordinated transmission schemes may involve communication between the APs 110, 120 and their OBSS stations 115a-c, 125a,b, i.e. between the APs 110, 120 and the non-AP stations 115a-c, 125a,b associated with other APs. For example, as already described above, for CoBF transmission an AP 110, 120 may perform a sounding procedure and may request sounding feedback reports both from the non-AP stations associated with it as well as the non-AP stations associated with other APs (also referred to as OBSS, i.e. Overlapping non-AP stations).

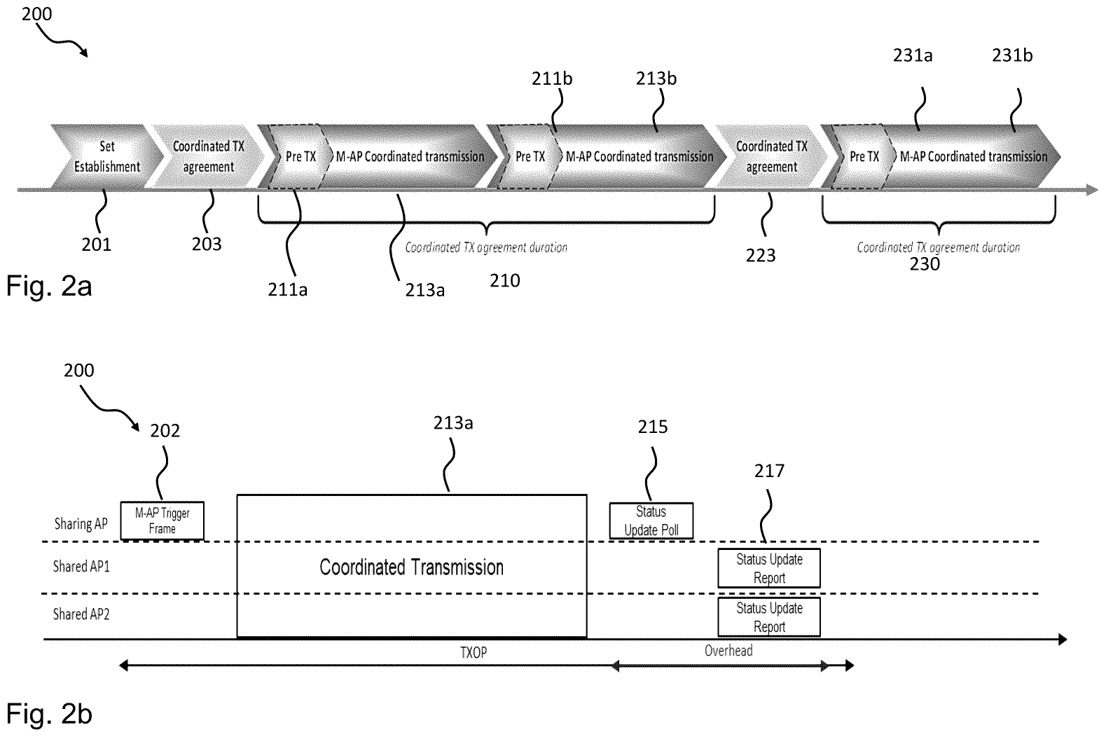

FIG. 2a illustrates a conventional M-AP coordinated transmission flow scheme 200. The M-AP coordinated transmission flow scheme 200 shown in FIG. 2 comprise the following main stages. In a stage 201 a set of APs is determined to participate in the coordinated transmission (this set is referred to as the Multi-AP or M-AP set). In a coordinated transmission agreement stage 203, 223 all member APs of the M-AP set or a subset thereof agree to share each obtained TXOP or part of thereof with at least one other member AP operating under the same agreement. The coordination agreement may last for several TXOPs 213a-b, 231b where specific participants, i.e. the shared APs 120 may be exchanged among TXOPs. As already described above, each TXOP may be owned by a different AP (referred to as the sharing AP 110) while all the other APs, i.e. the shared APs 120 may transmit only when triggered to do so by the sharing AP 110, as illustrated by the Pre-TX stages 211a, 211b, 231a in FIG. 2. The sharing AP 110 decides how to share the resources and with which APs in the current TXOP (this may be announced by the sharing AP and approved by the shared APs).

As further illustrated in FIG. 2a, a M-AP coordinated operation 210, 230 might be defined for a specific time-period and may be changed or terminated/restarted afterwards. This may for example comprise a time limitation in order to allow the Wi-Fi network 100 its dynamic behavior and some parameters/processes to be tracked and modified accordingly.

M-AP operation principles discussed by IEEE define two main roles of the sharing AP 110 and the shared AP 120, where only the sharing AP 110, i.e. the holder of a current TXOP may initiate the M-AP coordinated transmission/procedure. All the Shared APs 120 have to be triggered by sharing AP 110 in order to start transmitting.

This raises the question how the shared AP 120 may inform the sharing AP 110 and/or other APs regarding any change/update relevant for a current M-AP coordinated transmission operation. For example, how the shared AP 120 may indicate that it wants to quit a coordination agreement. Although the specific idea of terminating the M-AP coordinated transmission operation was discussed and mentioned in prior art, there is no in detail solution provided for shared AP 120.

Current prior art ideas provide no solution for shared AP 120 to indicate any change related to M-AP operation, in particular more than the intention of a shared AP 120 to terminate its participation in a coordination agreement under a M-AP set. Thus, there is a need to allow the shared AP120 to provide relevant information regarding any change that might affect the operation of the M-AP coordination transmission in a simple and efficient way.

As schematically illustrated in FIG. 2b, a TXOP 213a is started following a M-AP trigger frame 202. The problem here is that the sharing AP 110 doesn't know when any shared AP 120 has anything important to indicate. A simple way is to create a poll frame 215 where the shared AP 120 are actively requested to indicate if there any change in coordination parameters, for example by sending a status update report 217. However, for preventing the shared AP 120 to wait too long for an opportunity to indicate this, the poll 215 has to be sent frequently (for example, each TXOP 213a-b, 231b). On the other hand, most of the time, Shared APs have no change to be indicated thus, sending this poll 215 frequently results in overhead.

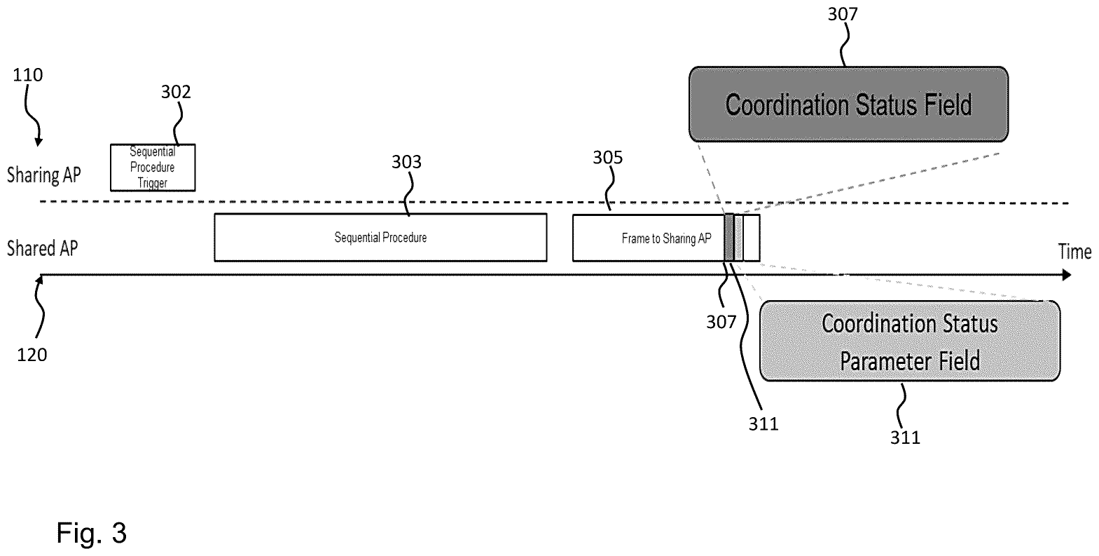

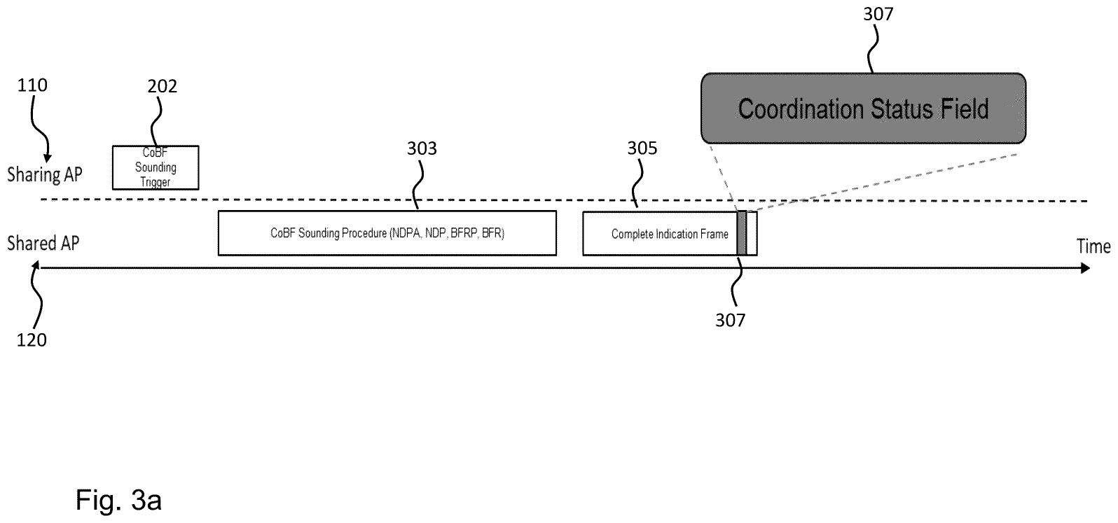

FIG. 3 shows a pre-transmission (Pre-TX) stage of M-AP coordinated transmission, implemented by the sharing AP 110 according to an embodiment and the shared AP 120 according to an embodiment. As illustrated in FIG. 3, a sequential procedure trigger frame 302 may be sent by the sharing AP 110 that initiates the sequential procedure 303 with each of the shared APs operating under the same coordination agreement. Once the sequential procedure 303, which may include further exchanges of frames, has been completed, the shared AP 120 may send a frame 305 to the sharing AP 110. FIG. 3a illustrates a more specific example of FIG. 3 in that the sequential procedure 303 in FIG. 3a is a coordinated beamforming (CoBF) sounding procedure performed by the sharing AP 110 and the shared AP 120. In the more specific example of FIG. 3a the sharing AP 110 sends a CoBF sounding trigger frame 202 to the shared AP 120. The CoBF sounding procedure 303 may involve several frames exchanged between the shared APs 120 and its associated non-AP STAs and/or (unassociated) OBSS non-AP STAs. Once the CoBF sounding procedure 303 illustrated in FIG. 3a has been completed, the shared AP 120 may send a compete indication frame 305 to the sharing AP 110.

As schematically illustrated in FIGS. 3 and 3a and explained in more detail below, the main idea of the present application is the inclusion of a new field, designated as coordination status field 307 by the shared AP 120 in any frame 305 transmitted to the sharing AP 110, in addition to other data. The coordination status field 307 may be a short field, i.e. from several bits up to few bytes which may indicate that a specific change is required and may also provide a short relevant information regarding the modified parameters. This allows the shared AP 120 to inform the sharing AP 110 on any frame 305 that it transmits to the sharing AP 110, in particular during a TXOP 213a, 213b, 231a of a change of the coordinated transmission agreement 203, 223.

As already described above, the shared access point, AP, 120 is configured to participate in a coordinated transmission to one or more non-AP stations 125a,b associated with the shared AP 120 and one or more further non-AP stations 115a-c associated with the sharing AP 110 making use of at least a portion of at least one TXOP 213a, 213b, 231a obtained and shared by a sharing AP 110 operating under a coordinated transmission agreement 203, 223 (also referred to as coordination agreement) within a Multi-AP, M-AP, set.

The processing circuitry 121 of the shared AP 120 is configured to modify at least one parameter of a plurality of coordination operation related parameters used by the shared AP 120 for the coordinated transmission.

The communication interface 123 of the shared AP 120 is configured to include the coordination status field 307 within the frame 305 transmitted to the sharing AP 110. The coordination status field 307 comprises information indicative of the at least one modified parameter of the plurality of coordination operation related parameters. Complementary, the communication interface 113 of the sharing AP 110 is configured to receive the frame 305 from the shared AP 120 which may be one of the plurality of shared APs 120.

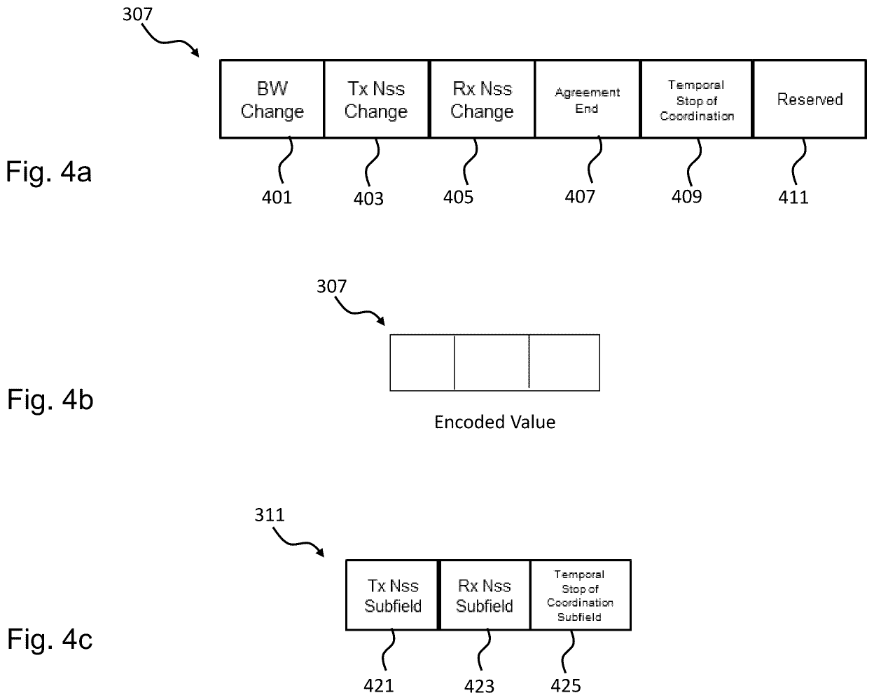

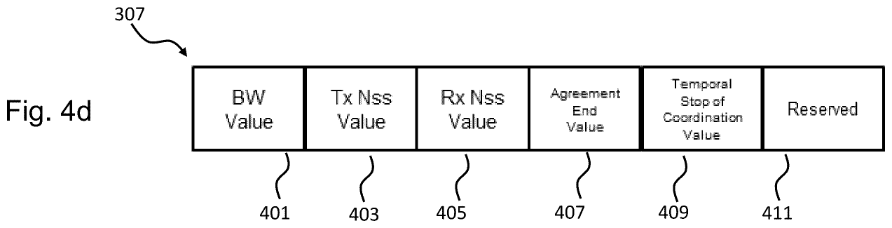

FIG. 4a shows a schematic diagram illustrating a suggested format of the coordination status field 307 which can be included in the frame 305 sent by the shared AP 120 according to an embodiment. As schematically illustrated in FIG. 4a, the coordination status field 307 may comprise a bitmap. Each bit 401-411 of the bitmap may correspond to one parameter of the plurality of coordination operation related parameters. A value of each bit 401-411 may be indicative of whether the corresponding parameter has been modified, i.e. each bit 401-411 may be set to a true/false state to indicate a specific change.

The bitmap may comprise a plurality of bits 401-411. As exemplary illustrated in FIG. 4a, the bitmap may comprise 6 bits. As will be appreciated, the bitmap may alternatively comprise less than 6 bits or more than 6 bits.

As further illustrated in FIG. 4a, the plurality of coordination operation related parameters used for the coordinated transmission by the shared AP 120, in particular the bits of the bitmap, may comprise a first parameter 401 indicative of a change in the coordinated transmission bandwidth, a second parameter 403 indicative of a change in the number of transmission spatial streams for the coordinated transmission, a third parameter 405 indicative of a change in the number of reception spatial streams for the coordinated transmission, a fourth parameter 407 indicative of the shared AP 120 no longer being a member of the current coordination agreement within the M-AP set, a fifth parameter 409 indicative of a pause of the shared AP 120 participating in the coordinated transmission taking place in any time portion till the end of the coordination agreement and/or a sixth parameter 411 reserved for further or application-specific indications. As will be appreciated, the order of the parameters 401-411 may be arbitrarily selectable.

Alternatively, the coordination status field 307 may comprise an encoded value of a set of encoded values as illustrated in FIG. 4b. Each encoded value may correspond to one parameter of the plurality of coordination operation related parameters and may be indicative of whether the corresponding parameter has been modified. The set of encoded values may indicate analogously to the first to sixth parameters 401-411 the corresponding parameters. The set of encoded values may further comprise a value indicating no change of the at least one parameter of the plurality of coordination operation related parameters.

For example, the set of encoded values may comprise a plurality of sequences of 3-bit values. The encoded values may be associated to indicate a status as follows: The sequence “000” may be indicative of no change of the at least one parameter of the plurality of coordination operation related parameters, the sequence “001” may be indicative of a change in the coordinated transmission bandwidth, the sequence “010” may be indicative of a change in the number of transmission spatial streams for the coordinated transmission, the sequence “011” may be indicative of a change in the number of reception spatial streams for the coordinated transmission, the sequence “100” may be indicative of the shared AP 120 no longer being a member of the current coordination agreement within the M-AP set, the sequence “101” may be reserved for further or application-specific indications and the sequence “111” may be indicative of a pause of the shared AP 120 participating in the coordinated transmission taking place in any time portion till the end of the coordination agreement. As will be appreciated, the association of the sequences may be arbitrarily selectable.

FIG. 4c shows a schematic diagram illustrating a format of a coordination status parameter field 311 that can be included in the frame 305 sent by the shared AP 120 according to an embodiment. As schematically illustrated in FIG. 4b, the frame 305 may further comprise the coordination status parameter field 311 comprising information indicative of a value of the at least one modified parameter of the plurality of coordination operation related parameters.

The coordination status parameter field 311 may allow providing more detailed information for some changes, for example specifying a new value of the updated parameter. The coordination status parameter field 311 may be transmitted following the coordination status field 307. The coordination status parameter field 311 may comprise one or more subfields 421, 423, 425, as illustrated in FIG. 4c, in particular depending on the number of changes, which are for example 4 bits each.

In the case of the bitmap format, there may be multiple subfields 421, 423, 425 corresponding to each indicated change. In the case of the encoded values format, there may be a single subfield corresponding to the indicated change.

For example, as illustrated in FIG. 4c, the coordination status parameter field 311 may comprise a first subfield 421 indicating a new value of number of transmission spatial streams for the coordinated transmission, a second subfield 423 indicating a new value of number of reception spatial streams for the coordinated transmission and/or a third subfield 425 indicating a time period declared for a temporal stop in units of time or (number of) TXOPs of a pause of the shared AP 120 participating in the coordinated transmission under the current coordination agreement.

FIG. 4d shows a schematic diagram illustrating a further possible format of the coordination status field 307 which may be included in the frame 305 transmitted by the shared AP 120 according to an embodiment. As schematically illustrated in FIG. 4d, in this embodiment, the coordination status field 307 may comprise a plurality of subfields 401-411, wherein each subfield may comprise the actual value of the corresponding operation related parameter. In an embodiment, the set of values of each of coordination operation related parameters may include a value indicating no change of the corresponding parameter. By way of example, the coordination status field illustrated in FIG. 4d comprises a subfield 401 for the value of the coordinated transmission bandwidth, a subfield 403 for the number of transmission spatial streams for the coordinated transmission, a subfield 405 for the number of reception spatial streams for the coordinated transmission, a subfield 407 for the value of the parameter indicative of a pause of the shared AP 120 participating in the current coordinated transmission taking place in any time portion till the end of the coordination agreement, a subfield 409 for the value of the parameter indicative of the shared AP 120 no longer being a member of the coordination agreement within the M-AP set, and a reserved subfield 411.

Generally, the transmission of the coordination status field 307 may be performed according to a first transmission mode, a second transmission mode or a third transmission mode. As will be appreciated, the shared AP 120 and the sharing AP 110 may be configured to operate based on the first transmission mode, the second transmission mode and/or the third transmission mode.

In the first transmission mode, i.e. an unsolicited mode, the shared AP 120 may decide on its own to add the coordination status field 307 and optionally the coordination status parameter field 311 to any frame 305 sent to the sharing AP, for example, it can be part of the complete indication frame 305, as illustrated in FIG. 3b.

The second transmission mode, i.e. a solicited mode, may comprise a coordination status request indication. The sharing AP 110 may indicate the shared AP 120 to transmit the coordination status field 307 and optionally the coordination status parameter field 311 in the upcoming M-AP coordination related frame. For example, the M-AP trigger frame 302 that initiates a sequential procedure may include this indication, and the shared AP 120 may transmit the coordination status field within the complete indication frame 305, as illustrated in FIG. 3b.

More specifically, in the second transmission mode, the communication interface 113 of the sharing AP 110 may be configured to send the trigger frame 302 to the shared AP 120 for informing the shared AP 120 to transmit the frame 305 to the sharing AP 110 and the communication interface 123 of the shared AP 120 may be configured to transmit the frame 305 to the sharing AP 110, after receiving the trigger frame 302 from the sharing AP 110.

The third transmission mode may comprise a M-AP coordination status poll. The sharing AP 110 may send a dedicated frame or add an indication to the M-AP trigger frame 202 and request the shared APs 120 to transmit a frame containing the coordination status update field 307 and optionally the coordination status parameter field 311. In this third transmission mode the shared AP 120 should transmit a dedicated response frame immediately after receiving a poll frame or an indication in the trigger frame.

More specifically, in the third transmission mode, the communication interface 113 of the sharing AP 110 may be configured to send a coordination status poll frame to the shared AP 120 and the communication interface 123 of the shared AP 120 may be configured to receive the coordination status poll frame from the sharing AP 110 and in response transmit the frame 305 to the sharing AP 110.

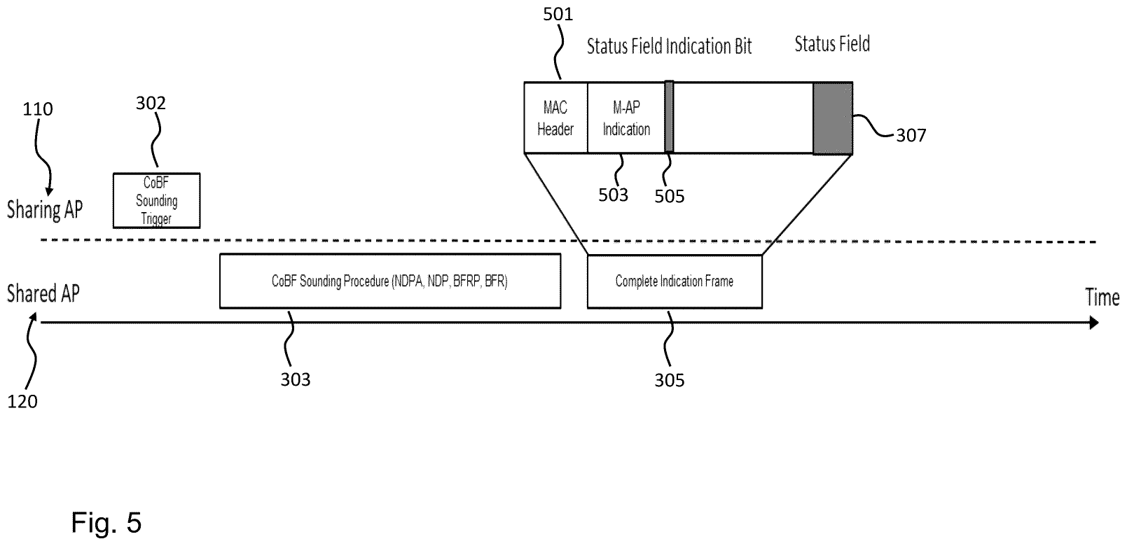

FIG. 5 shows a schematic diagram illustrating a coordination status field 307 presence indication in the frame 305 send by the shared AP 120 according to an embodiment. In the first transmission mode, when the shared AP 120 decides to add a status update in the frame 305 it may indicate the sharing AP 110 that the status update is transmitted by the coordination status field 307.

As illustrated in FIG. 5, the frame 305 may be for example the complete indication frame which may comprise a MAC Header field 501 and a M-AP indication field 503. The M-AP indication filed 503 may include a plurality of subfields, such as a M-AP set identifier subfield, a coordination agreement identifier subfield, a subfield for addresses and/or identifiers of APs and the like. The indication for the presence of status update being included in the current frame may be done by an indication 505, in particular a single flag bit 505. The flag bit may for example be set to “1” if the coordination status field 307 is contained in the frame 305. As further illustrated in FIG. 5, the coordination status field 307 may be transmitted as the first field or the last field of the payload in the frame 305.

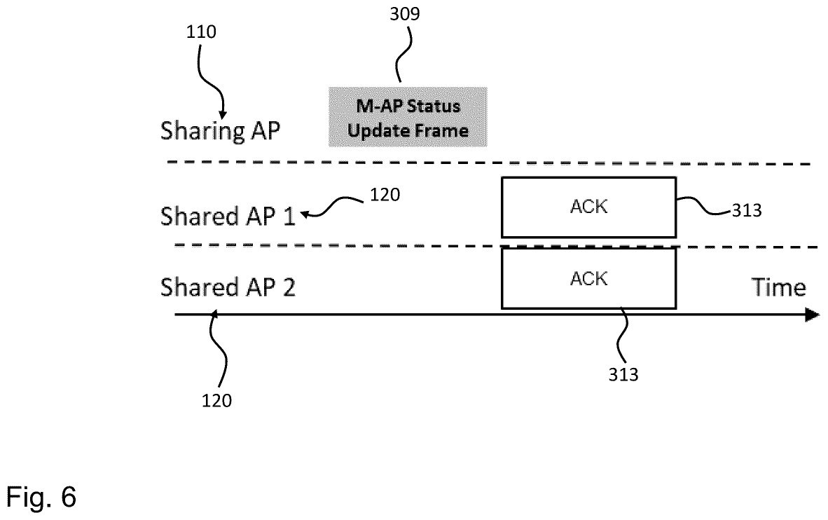

FIG. 6 shows a schematic diagram illustrating a transmission of a M-AP status update frame 309 by the sharing AP 110. The M-AP status update frame 309 may be transmitted by the sharing AP 110 to indicate one or more specific updates/changes. The M-AP status update frame 309 may be transmitted to a specific AP or to several Shared APs including unicast information to each of the APs. Alternatively, the M-AP status update frame 309 may be transmitted as a broadcast frame to all the relevant shared APs, in particular to all the shared APs 120 in range of the sharing AP 110. The M-AP status update frame 309 may be transmitted upon the coordination status field 307 being sent by any shared AP 120 or in case the sharing AP 110 needs to indicate the change. In case the M-AP status update frame 309 is transmitted as unicast frame it may require an ACK frame 313 from the intended recipients.

The M-AP status update frame may comprise a M-AP set identifier indicative of the M-AP set, the coordination status field 307, the coordination status parameters field 311 if required by the corresponding transmission mode and/or in particular a coordination agreement identifier within the M-AP set. The coordination agreement identifier may identify one coordination agreement of a plurality of coordination agreements within the M-AP set, under which coordination agreement identified by the coordination agreement identifier within the M-AP set the sharing AP 110 and the shared AP 120 operate.

More specifically, the communication interface 113 of the sharing AP 110 may be configured to transmit the M-AP status update frame 309 to at least one further shared AP 120 of the plurality of shared APs 120 and the communication interface 123 of the shared AP 120 is configured to receive the status update frame 309 from the sharing AP 110. The status update frame 309 may comprise the coordination status field 307 comprising the information indicative of an identity of the at least one modified parameter of the plurality of coordination operation related parameters, wherein the at least one parameter has been modified by the sharing AP 110 or a further shared AP 120 of the current coordination agreement. In response to receiving the status update frame 309 from the sharing AP 110, the communication interface 123 may be configured to transmit an acknowledgment frame 311 to the sharing AP 110.

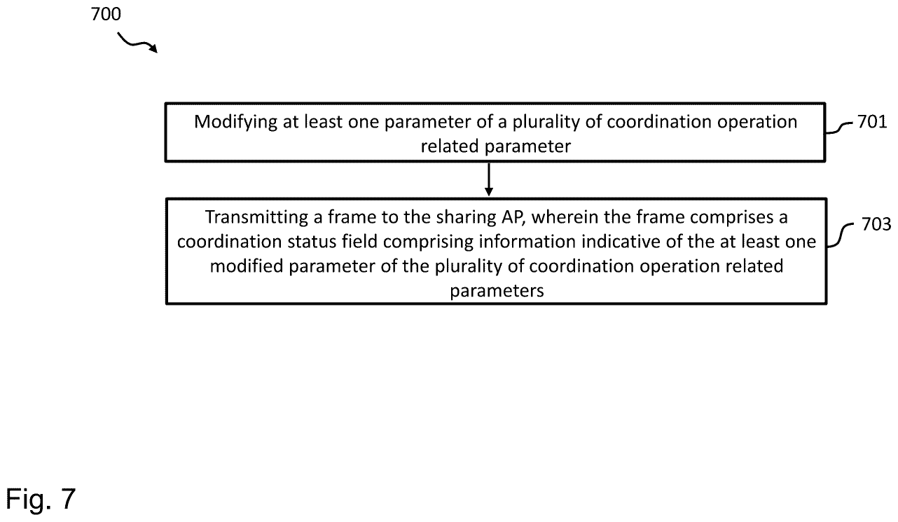

FIG. 7 is a flow diagram illustrating a method 700 of operating the shared access point, AP, 120 according to an embodiment. As already described above, the shared AP 120 is configured to participate in a coordinated transmission to one or more non-AP stations 125a,b associated with the shared AP 120 and one or more further non-AP stations 115a-c associated with the sharing AP 110 making use of at least a portion of at least one transmission opportunity, TXOP, obtained and shared by the sharing AP 110 operating under a coordination agreement within the Multi-AP, M-AP, set.

The method 700 comprises a step 701 of modifying at least one parameter of a plurality of coordination operation related parameters used by the shared AP 120 for the coordinated transmission.

The method 700 further comprises a step 703 of including a coordination status field 307 within a frame 305 transmitted to the sharing AP 110, wherein the coordination status field 307 comprises information indicative of the at least one modified parameter of the plurality of coordination operation related parameters. As already described above, in an embodiment, the frame in addition to the coordination status field may further comprise the coordination status parameter field 311.

As the method 700 can be implemented by the shared AP 120, further features of the method 700 result directly from the functionality of the shared AP 120 and its different embodiments described above and below.

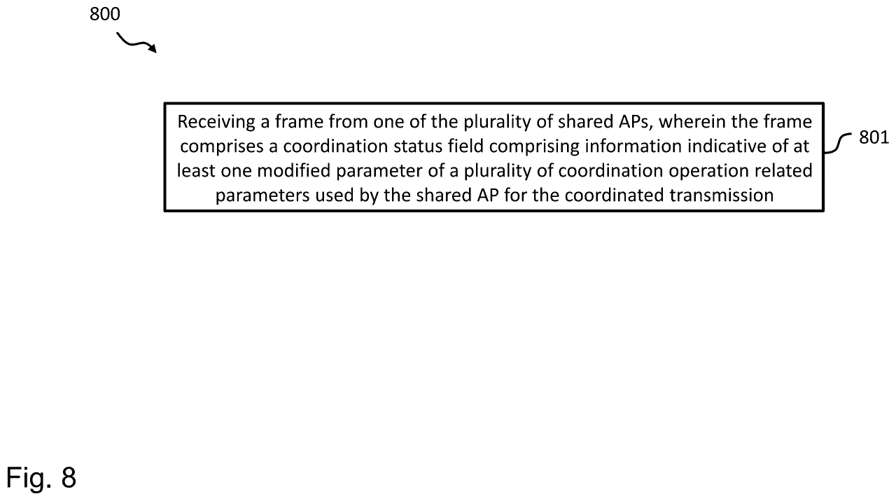

FIG. 8 is a flow diagram illustrating a method 800 of operating the sharing access point, AP, 110 according to an embodiment. As already described above, the sharing AP 110 is configured to share at least a portion of a transmission opportunity, TXOP, with the plurality of shared APs 120 operating under a coordination agreement within the Multi-AP, M-AP, set for participating in a coordinated transmission to one or more non-AP stations 115a-c associated with the sharing AP 110 and a plurality of further non-AP stations associated with the plurality of shared APs 120.

The method 800 comprises a step 801 of receiving the frame 305 from one of the plurality of shared APs 120, wherein the frame 305 comprises the coordination status field 307 comprising information indicative of an identity of at least one modified parameter of a plurality of coordination operation related parameters used by the shared AP 120 for the coordinated transmission. As already described above, the shared AP 120 may further include an indication for the presence of the coordination status field 307 in any frame transmitted by the shared AP 120 during the pre-transmission stage.

The method 800 may further comprise a step of transmitting the status update frame 309 to at least one further shared AP 120 of the plurality of shared APs 120, wherein the status update frame 309 comprises the coordination status field 307 comprising the information indicative of an identity of the at least one modified parameter of the plurality of coordination operation related parameters.

The method 800 may further comprise soliciting the shared AP 120 to transmitting the frame 305 to the sharing AP 110 by transmitting a coordination status poll frame to the shared AP 120.

As the method 800 can be implemented by the sharing AP 110, further features of the method 800 result directly from the functionality of the sharing AP 110 and its different embodiments described above and below.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments disclosed herein may be integrated into one processing unit, or each of the units may exist alone physically, or two or more units are integrated into one unit.

1. A shared access point, AP, (120) configured to participate in a coordinated transmission making use of at least a portion of at least one transmission opportunity, TXOP, obtained and shared by a sharing AP (110) operating under a coordination agreement within a Multi-AP, M-AP, set, wherein the shared AP (120) comprises:
a processing circuitry (121) configured to modify at least one parameter of a plurality of coordination operation related parameters; and
a communication interface (123) configured to include a coordination status field (307) within a frame (305) transmitted to the sharing AP (110), wherein the coordination status field (307) comprises information indicative of the at least one modified parameter of the plurality of coordination operation related parameters.

2. The shared AP (120) of claim 1, wherein the frame (305) further comprises an indication (505) indicating the presence of the coordination status field (307) in the frame (305).

3. The shared AP (120) of claim 1, wherein the coordination status field (307) comprises a bitmap, wherein each bit of the bitmap corresponds to one parameter of the plurality of coordination operation related parameters and wherein a value of each bit is indicative of whether the corresponding parameter has been modified.

4. The shared AP (120) of claim 3, wherein the bitmap comprises a plurality of bits.

5. The shared AP (120) of claim 1, wherein the coordination status field (307) comprises an encoded value of a set of encoded values, wherein each encoded value corresponds to one parameter of the plurality of coordination operation related parameters and is indicative of whether the corresponding parameter has been modified.

6. The shared AP (120) of claim 5, wherein the set of encoded values comprises a plurality of sequences of 3-bit values.

7. The shared AP (120) of claim 5, wherein the set of encoded values comprises a value indicating no change of the at least one parameter of the plurality of coordination operation related parameters.

8. The shared AP (120) of claim 3, wherein the frame (305) further comprises a coordination status parameter field (311) comprising information indicative of a value of the at least one modified parameter indicated in the coordination status field (307) of the plurality of coordination operation related parameters.

9. The shared AP (120) of claim 1, wherein the coordination status field (307) comprises a set of subfields where each subfield comprises a value of one of the coordination operation related parameters of the set of values corresponding to that parameter.

10. The shared AP (120) of claim 9, wherein the set of values of each of coordination operation related parameters includes a value indicating no change of the corresponding parameter.

11. The shared AP (120) of claim 1, wherein the plurality of coordination operation related parameters comprises a parameter indicative of a change in the coordinated transmission bandwidth, a parameter indicative of a change in the number of transmission spatial streams for the coordinated transmission, a parameter indicative of a change in the number of reception spatial streams for the coordinated transmission, a parameter indicative of a pause of the shared AP (120) participating in the current coordinated transmission taking place in any time portion till the end of the coordination agreement and/or a parameter indicative of the shared AP (120) no longer being a member of the coordination agreement within the M-AP set.

12. The shared AP (120) of claim 1, wherein the communication interface (123) is configured to transmit the frame (305) to the sharing AP (110), after receiving a trigger frame (302) from the sharing AP (110).

13. The shared AP (120) of claim 1, wherein the communication interface (123) is configured to receive a coordination status poll frame from the sharing AP (110) and to transmit the frame (305) to the sharing AP (110) in response to the transmission of the coordination status poll frame.

14. The shared AP (120) of claim 1, wherein the communication interface (123) is configured to receive a M-AP status update frame (309) from the sharing AP (110), wherein the M-AP status update frame (309) comprises a coordination status field (307) comprising information indicative of at least one parameter of a plurality of coordination operation related parameters, wherein the at least one parameter has been modified by the sharing AP (110) or a further shared AP (120) of the current coordination agreement.

15. The shared AP (120) of claim 14, wherein, in response to receiving the M-AP status update frame (309) from the sharing AP (110), the communication interface (123) is configured to transmit an acknowledgment frame (313) to the sharing AP (110).

16. The shared AP (120) of claim 14, wherein the M-AP status update frame (309) comprises a M-AP set identifier indicative of the M-AP set.

17. The shared AP (120) of claim 14, wherein the M-AP status update frame (309) further comprises a coordination agreement identifier within the M-AP set, wherein the coordination agreement identifier identifies one coordination agreement of a plurality of coordination agreements within the M-AP set and wherein the sharing AP (110) and the shared AP (120) operate under the coordination agreement identified by the coordination agreement identifier within the M-AP set.

18. A method (700) of operating a shared access point, AP, configured to participate in a coordinated transmission making use of at least a portion of at least one transmission opportunity, TXOP, obtained and shared by a sharing AP (110) operating under a coordination agreement within a Multi-AP, M-AP, set, wherein the method (700) comprises:
modifying (701) at least one parameter of a plurality of coordination operation related parameters; and
Including a coordination status field (307) within a frame (305) transmitted to the sharing AP (110), wherein the coordination status field (307) comprises information indicative of the at least one modified parameter of the plurality of coordination operation related parameters.

19. A sharing access point, AP, (110) configured to share at least a portion of a transmission opportunity, TXOP, with a plurality of shared APs (120) operating under a coordination agreement within a Multi-AP, M-AP, set for participating in a coordinated transmission, wherein the sharing AP (110) comprises:
a communication interface (113) configured to receive a frame (305) from one of the plurality of shared APs (120), wherein the frame (305) comprises a coordination status field (307) comprising information indicative of at least one modified parameter of a plurality of coordination operation related parameters used by the shared AP (120) for the coordinated transmission.

20. The sharing AP (110) of claim 19, wherein the frame (305) further comprises an indication (505) indicating the presence of the coordination status field (307).
